(19) United States
(12) Patent Application Publication
(10) Pub. No.: US 2026/0184120 A1
(43) Pub. Date: Jul. 2, 2026

(54) SOUNDPROOF TYRE FOR VEHICLE WHEELS

(71) Applicant: Pirelli Tyre S.p.A., Milano (IT)

(72) Inventors: Antonio SUSANNA, Milano (IT); Raffaella DONETTI, Milano (IT); Antonio MONTEROSSO, Milano (IT); Thomas HANEL, Milano (IT)

(73) Assignee: Pirelli Tyre S.p.A., Milano (IT)

(21) Appl. No.: 19/127,376

(22) PCT Filed: Nov. 6, 2023
(86) PCT No.: PCT/IB2023/061170

§ 371 Date: May 5, 2025

(30) Foreign Application Priority Data
Nov. 11, 2022 (IT) 102022000023334

(51) Int. Cl. B60C 19/00; B60C 1/00; C08J 9/00; C08J 9/10; C08L 7/00

(52) U.S. Cl. CPC B60C 19/002; B60C 1/00; C08J 9/0061; C08J 9/103; C08L 7/00; C08J 2203/04; C08J 2307/00; C08J 2409/00; C08J 2461/06; C08J 2467/04; C08L 2205/035; C08L 2312/00

(57) ABSTRACT

The present invention relates to a soundproof tyre for vehicle wheels comprising at least one noise-reducing element made by vulcanisation of a cross-linkable and expandable elastomeric compound comprising at least one diene elastomeric polymer, at least one expanding agent, at least one cross-linking resin, at least one polymer or copolymer of a hydroxy acid and optionally, an agent selected from the group of fatty acid amides.

The present invention relates to a soundproof tyre for vehicle wheels. More specifically, the invention relates to a soundproof tyre comprising at least one noise-reducing element, i.e. capable of reducing the noise perceived in the passenger compartment of vehicles, due to the attenuation of the cavity and/or rolling noise of the tyre itself.

### BACKGROUND ART

In the automotive industry there is a growing demand to improve driver and passenger comfort, particularly to reduce the noise of vehicles, especially high-end vehicles.

The automotive industry tends to produce ever lighter vehicles, and/or provided with ever more silent engines—such as electric motors—in which, by contrast, road noises are perceived with more annoyance.

The problem of reducing the cavity and/or rolling noise is therefore increasingly felt for both high range vehicles, in which comfort and, specifically soundproofing, are important requirements, and for sports cars, for which in fact a lowered distribution and particularly stiff damping and transmission systems are typical, which substantially do not attenuate the noise, which is transmitted virtually unchanged from the tyres to the compartment.

In order to reduce this type of noise it is known to introduce sound-absorbing materials in the internal cavity of the tyres, either in free form or by fixing strips thereof on the internal surface of the liner. The sound-absorbing material is capable of breaking down the sound wave, converting the energy of the incident sound into heat. The sound-absorbing material typically consists of foams of heat-resistant expanded polymers, such as, for example, foams of polyurethanes or elastomeric polymers (natural rubber, butyl rubber, etc.).

A soundproof tyre for vehicle wheels typically comprises a noise-reducing element in the internal cavity, preferably fixed in the form of stripes on the internal surface of the liner.

The noise-reducing element is able in particular to mitigate the so-called cavity noise. Said cavity noise is generated during the rolling of the tyre on the road, when the air present in the internal annular cavity is placed in vibration, as it is cyclically compressed in the tread crushing step, thus generating sound waves that are amplified by resonance. Cavity noise then propagates to the passenger compartment of the vehicle, by transmission through the rim, the hub, the suspension and the frame, and is perceived as very annoying by passengers.

The frequencies at which the air resonates in the cavity are inversely proportional to the tyre circumference, and depend, among other things, also on the shape of the cavity itself, on the nature and shape of the materials that internally line it. Indicatively, the resonance frequency can range from about 50 to 400 Hz, typically around 180-220 Hz for car tyres, with a diameter of about 600 to 800 mm and 130-150 Hz for tyres of heavy vehicles, with a diameter of about 750 to 1200 mm. Soundproof tyres are known in the art, and are described in numerous patent application publications, such as for example WO2017163219, WO2016051371, WO2015149959, US20080264539 and US20130087267.

In particular, US20120247637 describes a soundproof tyre comprising a noise-reducing element consisting of a rubber layer placed on the internal surface of the tyre, where such rubber layer is made with a vulcanisable composition comprising an elastomeric polymer, for example natural rubber or butyl rubber, a reinforcing agent, for example silica or carbon black, an expanding agent, for example azodicarbonamide, and a hot-melt agent with a melting point of between 70° C. and 150° C., for example urea, the latter component being necessary to reduce expansion and control the uniformity of the layer thickness during vulcanisation, and to significantly increase the soundproofing capacity of the resulting vulcanised layer. Patent application PCT/IB2022/054423 filed on May 12, 2022 describes a noise-reducing element of a tyre, arranged on the liner in the internal cavity, obtained from a composition comprising at least one diene elastomeric polymer, at least one reinforcing agent, at least one vulcanising agent, at least one expanding agent, at least one agent selected from the group of fatty acid amides and at least one agent selected from the group of polymers and copolymers of caprolactone, lactic acid, glycolic acid, and mixtures thereof.

Alternatively or in addition to the arrangement in the internal cavity, the noise-reducing element may be placed inside the carcass structure.

For example, WO2015014577A1 describes a soundproof tyre comprising an expanded noise-reducing element placed internally to the carcass structure. The noise-reducing element is obtained by expansion and vulcanisation of a composition comprising one or more elastomeric polymers, a reinforcing agent, an expanding agent, typically a carbonate or bicarbonate, a carboxylic acid which upon reaction with the carbonate develops carbon dioxide, a sulphur vulcanising agent and an accelerant agent.

However, the presence of significant amounts of sulphur vulcanising agent in these compositions may hinder the expansion of the material and, consequently, the sound absorption.

### SUMMARY OF THE INVENTION

Although the solutions described in the art, and in particular in US20120247637, give interesting results, the Applicant has noted that the use of urea in elastomeric materials for the manufacture of tyres involves a series of contraindications.

First, in general terms, urea has a pKb dissociation constant of 0.1 at 21° C. (Perrin, D.D. (1965) Dissociation constants of Organic Bases in Aqueous Solutions. Butterworth, London), and consequently it is a chemical agent that irritates the skin and eyes which makes it difficult to handle in the industrial sector.

Furthermore, as also described in U.S. Pat. No. 6,831,109, mixtures of urea and/or derivatives thereof in combination with organic dicarboxylic acids, such as oxalic acid, lead to a de-vulcanisation of the sulphur lattice S-S, creating an instability of the material. Finally, due to its chemical structure, polarity and molecular size, urea shows migration phenomena in the tyre compounds, affecting the vulcanising kinetics thereof and/or leading to unsightly surfacing phenomena on the tyre surface.

Furthermore, the Applicant wished to make the applicability of the noise-reducing elements inside the tyre versatile in order to maximise the sound-absorbing effect, therefore not limiting themselves to the use in the internal cavity but also or exclusively in the carcass structure of the tyre.

In this regard, the Applicant noted that the elastomeric composition, especially for application in the carcass, would have to satisfy conflicting needs, having to guarantee on the one hand a high expansion of the material being vulcanised, to provide adequate soundproofing, and on the other hand, a cross-linking suitable for guaranteeing the structural integrity of the element and its long-lasting adhesion to elastomeric compounds which may not be very compatible, even in conditions of intense stress, for sufficient structural solidity of the tyre. Therefore, the objective of imparting at the same time expandability and cross-linking to the compound of sound-absorbing elastomeric material appeared somewhat difficult.

The Applicant has therefore undertaken studies for manufacturing soundproof tyres for vehicle wheels comprising a noise-reducing element of foamed rubber made by vulcanising an elastomeric composition which may be vulcanised in the presence of an expanding agent without the aid of urea, and of general applicability inside the tyre.

The Applicant, after extensive experimentation, surprisingly found that the use of a combination of cross-linking resins, (co) polymers of hydroxy acids such as polycaprolactones and the like and, optionally, amides of fatty acids was able to perform the same function as urea, overcoming the contraindications deriving from such agent, obtaining satisfactory results in terms of noise reduction. The use of cross-linking agents as a partial or total replacement of the sulphur vulcanising agent not only made it possible to prevent problems of detachment in case of application of the element in the carcass, in contact with different compounds which were not very compatible but, surprisingly, did not compromise the expansion of the material and its sound-absorbing effectiveness.

Therefore, a first aspect of the present invention is a cross-linkable and expandable elastomeric compound obtained by mixing an elastomeric composition, wherein said elastomeric composition comprises:
(i) 100 phr of at least one natural or synthetic elastomeric polymer,
(ii) from 10 to 80 phr of at least one reinforcing filler,
(iii) from 0 to 3 phr of at least one vulcanising agent,
(iv) from 2 to 25 phr of at least one cross-linking resin,
(v) from 5 to 30 phr of at least one expanding agent,
(vi) from 0 to 40 phr of at least one agent selected from the fatty acid amides group, and
(vii) from 1 to 20 phr of at least one agent selected from the group of polymers and copolymers of one or more hydroxy acids, preferably selected from polymers and copolymers of caprolactone, lactic acid, glycolic acid, and mixtures thereof.

A further aspect of the present invention relates to a noise-reducing element made by cross-linking and expanding the cross-linkable and expandable elastomeric compound according to the invention.

A further aspect of the present invention relates to a soundproof tyre for vehicle wheels comprising
a carcass structure;
a tread band in a position radially outward from said carcass structure;
a vulcanised layer of air-impermeable elastomeric compound (liner), arranged radially inside the carcass structure;
at least one noise-reducing element made of expanded elastomeric material;
   wherein said at least one noise-reducing element is made by cross-linking and expanding a cross-linkable and expandable elastomeric compound according to the invention.

### Definitions

For the purposes of the present description and the following claims, the term “phr” (acronym for parts per hundreds of rubber) indicates the parts by weight of a given elastomeric compound component per 100 parts by weight of the elastomeric polymer, considered net of any extension oils.

The term “elastomeric composition” means a composition comprising at least one diene elastomeric polymer and one or more additives, which by mixing and possible heating provides an elastomeric compound suitable for use in tyres and components thereof.

The components of the elastomeric composition are not generally introduced simultaneously into the mixer but typically added in sequence. In particular, the vulcanisation additives, such as the vulcanisation agent and optionally the accelerant and retardant agents, and the cross-linking resin, are usually added in a downstream step with respect to the incorporation and processing of all the other components.

In the cross-linkable elastomeric compound, the individual components of the elastomeric composition may be altered or no longer individually traceable as modified, completely or in part, due to the interaction with the other components, of heat and/or mechanical processing. The term “elastomeric composition” herein is meant to include the set of all the components that are used in the preparation of the elastomeric compound, regardless of whether they are actually present simultaneously, are introduced sequentially or are then traceable in the elastomeric compound or in the final tyre.

The term “elastomeric polymer” indicates a natural or synthetic polymer which, after vulcanisation, may be stretched repeatedly at room temperature to at least twice its original length and after removal of the tensile load substantially immediately returns with force to approximately its original length (according to the definitions of the ASTM D1566-11 Standard terminology relating to Rubber).

The term “diene polymer” indicates a polymer or copolymer derived from the polymerisation of one or more different monomers, among which at least one of them is a conjugated diene (conjugated diolefin).

The term “vulcanising agent” typically indicates a sulphur-based cross-linking agent capable of transforming natural or synthetic rubber into elastic and resistant material due to the formation of a three-dimensional network of inter- and intra-molecular bonds. Typical vulcanising agents are sulphur-based agents such as elemental sulphur, polymeric sulphur, agents sulphur-donor such as bis [(trialkoxysilyl) propyl] polysulphides, thiurams, dithiodimorpholines and caprolactam-disulphide. As is known, other vulcanising agents such as peroxides are also used in the field.

The term “cross-linking resin” means a reactive resin capable of forming a three-dimensional network of inter- and intra-molecular bonds in a natural or synthetic rubber different from that obtained by reaction of the sulphur-based vulcanising agent. These differences are discussed for example in the article M. Akiba et al. Prog. Polym. Sci. Vol. 22, 475-521, 1997. Typical cross-linking agents used in the field are, for example, phenol-formaldehyde resins and the like.

The term “elastomeric compound” indicates the compound obtainable by mixing and optionally heating at least one elastomeric polymer with at least one of the additives commonly used in the preparation of tyre compounds.

The term “cross-linkable and expandable elastomeric compound” indicates the elastomeric compound ready for cross-linking and the simultaneous expansion, obtainable by incorporation into an elastomeric compound of all the additives, including the cross-linking resin, the expanding agents and, if present, the vulcanising agents.

The term “expanded cross-linked elastomeric compound” refers to the material obtained by cross-linking and expanding a cross-linkable and expandable elastomeric compound.

The term “green” indicates a material, a compound, a composition, a component or a tyre not yet cross-linked.

The term “cross-linking” means the formation of a three-dimensional network of inter- and intra-molecular bonds in a natural or synthetic rubber induced by a cross-linking agent.

The term “vulcanisation” refers to the cross-linking reaction in a natural or synthetic rubber induced by a typically sulphur-based vulcanising agent.

The term “expansion” refers to the increase in volume of the cross-linkable and expandable elastomeric compound caused by the generation and trapping of gas induced by an expanding agent during cross-linking. In the present context, the cross-linking and expanding reaction preferably occurs during the vulcanisation of the tyre in the mould.

The term “expanding agent” refers to an agent capable of generating gas by heating the cross-linkable and expandable elastomeric compound to the cross-linking temperature. Preferably, such temperature is reached or exceeded during the vulcanisation of the tyre.

The term “vulcanisation accelerant” means an agent capable of decreasing the duration of the vulcanisation process and/or the operating temperature, such as TBBS, sulphenamides in general, thiazoles, dithiophosphates, dithiocarbamates, guanidines, as well as sulphur donors such as thiurams.

The term “vulcanisation activating agent” indicates a product capable of further facilitating the vulcanisation, making it happen in shorter times and possibly at lower temperatures. An example of activating agent is the stearic acid-zinc oxide system. The term “vulcanisation retardant” indicates a product capable of delaying the onset of the vulcanisation reaction and/or suppressing undesired secondary reactions, for example N-(cyclohexylthio) phthalimide (CTP).

The term “vulcanisation package” is meant to indicate the vulcanising agent and one or more vulcanisation additives selected from among vulcanisation activating agents, accelerants and retardants.

The term “reinforcing filler” is meant to refer to a reinforcing material typically used in the sector to improve the mechanical properties of tyre rubbers, preferably selected from among carbon black, conventional silica, such as silica from sand precipitated with strong acids, preferably amorphous, diatomaceous earth, calcium carbonate, titanium dioxide, talc, alumina, aluminosilicates, kaolin, silicate fibres and mixtures thereof.

The term “white filler” is meant to refer to a conventional reinforcing material used in the sector selected from among conventional silica and silicates, such as sepiolite, palygorskite also known as attapulgite, montmorillonite, halloysite and the like, optionally modified by acid treatment and/or derivatised. Typically, white fillers have surface hydroxyl groups.

The term “mixing step (1)” indicates the step of the preparation process of the elastomeric compound in which one or more additives may be incorporated by mixing and optionally heating, except for the vulcanising agent which is fed in step (2). The mixing step (1) is also referred to as “non-productive step”. In the preparation of a compound there may be several “non-productive” mixing steps which may be indicated with 1a, 1b, etc.

The term “mixing step (2)” indicates the next step of the preparation process of the elastomeric compound in which the vulcanisation agent and, optionally, the other additives of the vulcanisation package are introduced into the elastomeric compound obtained from step (1), and mixed in the material, at controlled temperature, generally at a temperature of compound than 120° C., so as to provide the cross-linkable and expandable elastomeric compound. The mixing step (2) is also referred to as “productive step”.

Unless otherwise indicated, all the percentages are expressed as percentages by weight.

### DETAILED DESCRIPTION OF THE INVENTION

The elastomeric compound, the noise-reducing element and the soundproof tyre according to the present invention may exhibit at least one of the following preferred features, taken individually or in combination with the others.

The cross-linkable and expandable elastomeric compound of the noise-reducing element according to the present invention is obtainable from a composition which may comprise (i) at least one natural or synthetic diene elastomeric polymer derived from the polymerisation of one or more monomers, at least one of which is a conjugated diene, or (ii) at least one elastomeric polymer of one or more monoolefins with an olefinic comonomer or derivatives thereof.

The synthetic diene elastomeric polymer may be obtained by solution polymerisation, emulsion polymerisation or gas phase polymerisation of at least one conjugated diene, optionally mixed with at least one comonomer selected from monovinylarenes and/or polar comonomers in an amount not exceeding 60% by weight.

The conjugated dienes generally contain from 4 to 12, preferably from 4 to 8 carbon atoms and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene and mixtures thereof. 1,3-butadiene and isoprene are particularly preferred.

Monovinylarenes, which may optionally be used as comonomers, generally contain from 8 to 20, preferably from 8 to 12 carbon atoms and may be selected, for example, from: styrene; 1-vinylnaphthalene; 2-vinylnaphthalene; various alkyl, cycloalkyl, aryl, alkylaryl or arylalkyl derivatives of styrene, such as, for example, α-methylstyrene, 3-methylstyrene, 4-propylstyrene, 4-cyclohexylstyrene, 4-dodecylstyrene, 2-ethyl-4-benzylstyrene, 4-p-tolyl-styrene, 4-(4-phenylbutyl) styrene, and mixtures thereof. Styrene is particularly preferred.

Polar comonomers that may optionally be used, may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile and mixtures thereof.

Preferably, the diene elastomeric polymer which may be used in the present invention may be selected, for example, from among: cis-1,4-polyisoprene (natural or synthetic, preferably natural rubber), 3,4-polyisoprene, polybutadiene (in particular polybutadiene with a high content of 1,4-cis), isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, and mixtures thereof.

Monoolefins may be selected from: ethylene and α-olefins generally containing 3 to 12 carbon atoms, such as for example propylene, 1-butene, 1-pentene, 1-hexene, 1-octene or mixtures thereof. The following are preferred: copolymers selected from ethylene and an α-olefin, optionally with a diene; isobutene homopolymers or copolymers thereof with small amounts of a diene, which are optionally at least partially halogenated. The diene optionally present generally contains 4 to 20 carbon atoms and is preferably selected from: 1,3-butadiene, isoprene, chloroprene, neoprene, 1,4-hexadiene, 1,4-cyclohexadiene, 5-ethylidene-2-norbornene, 5-methylene-2-norbornene, vinylnorbornene or mixtures thereof. Among them, the following are particularly preferred: ethylene/propylene (EPR) copolymers or ethylene/propylene/diene (EPDM) copolymers; polyisobutene; butyl rubber; halobutyl rubbers, in particular chlorobutyl (CIIR) or bromobutyl (BIIR) rubbers; or mixtures thereof.

Preferably, the natural or synthetic diene elastomeric polymer of the present elastomeric composition is selected from natural rubber, synthetic isoprene rubber and mixtures thereof.

Preferably, the present elastomeric composition comprises only natural rubber, synthetic isoprene rubber and mixtures thereof as natural or synthetic diene elastomeric polymer.

The cross-linkable and expandable elastomeric compound of the noise-reducing element according to the present invention comprises at least one reinforcing filler, preferably selected from carbon black, conventional silica, such as sand silica precipitated with strong acids, preferably amorphous, diatomaceous earth, calcium carbonate, titanium dioxide, talc, alumina, aluminosilicates, kaolin, silicate fibres and mixtures thereof.

Preferably, the reinforcing filler is selected from carbon black, conventional silica, silicate fibres, talc and mixtures thereof.

Commercial examples of reinforcing fillers suitable for use in the present elastomeric composition are the carbon black N326 and N375 from Cabot, the carbon black N326 and N375 from Birla, and Minstron HAR lamellar talc produced by Imerys Talc France.

The elastomeric composition preferably comprises from 20 to 60 phr, more preferably from 20 to 50 phr of said reinforcing filler.

The elastomeric composition preferably comprises at least 30 phr, more preferably at least 40 phr of said reinforcing filler.

The cross-linkable and expandable elastomeric compound of the noise-reducing element according to the present invention may comprise at least one vulcanising agent, preferably, if present, a sulphur-based vulcanising agent.

The vulcanising agent, if present, is preferably selected from sulphur, sulphur-containing molecules (sulphur donors), preferably in the presence of agents containing zinc and fatty acids, or alternatively other conventional vulcanising agents such as peroxides.

The vulcanising agent may be sulphur preferably selected from soluble sulphur (crystalline sulphur), insoluble sulphur (polymeric sulphur), (iii) oil-dispersed sulphur and mixtures thereof.

Alternatively, sulphur donor molecules such as, for example, caprolactam disulphide (CLD), bis [(trialkoxysilyl) propyl]polysulphides, dithiophosphates, phosphoryl polysulphide (SDT) and mixtures thereof may be used.

Commercial examples of suitable vulcanisation agents are the 65% sulphur known under the trade name of Rhenogran of Lanxess, the 67% sulphur known under the trade name of Crystex OT33 of Eastman, the 95% sulphur known under the trade name of Solvay SchwefelKC, the rhombic crystalline sulphur known under the trade name of Sulphur (1% oil and 0.3% silica) of Zolfindustria.

The vulcanising agent may be present in the elastomeric composition of the invention in a total amount of less than 3.0 phr, preferably less than 2.5 phr, more preferably less than 2.0 phr or 1.0 phr.

The vulcanising agent, if present, is preferably used together with adjuvants such as vulcanisation activating agents, accelerants and/or retardants known to the man skilled in the art. The set of vulcanisation activating agents, accelerants and/or retardants constitutes, together with the vulcanising agent, the so-called “vulcanisation package”.

Preferably, the vulcanising agent is absent.

The present composition comprises, in addition to the agents, optional sulphur-based vulcanising agents or, preferably, in their replacement at least one cross-linking resin.

The Applicant has observed that the cross-linking resin allows a good cross-linking of the elastomeric material to be obtained without penalising the expansion of the material, as shown in FIG. 4, even for large amounts of cross-linker.

Preferably, the cross-linking resin is used in amounts between 2 and 25 phr, more preferably between 8 and 20 phr.

Typically, the cross-linking resin is a reactive resin comprising at least one methylene donor agent and at least one methylene acceptor agent.

The term “methylene donor agent” means formaldehyde or an organic agent derivative thereof which, under the usual vulcanisation conditions, can at least partially decompose releasing formaldehyde in situ, such as for example hexamethylenetetramine (HMT), hexamethoxymethylmelamine (HMMM), hexamethylol melamine, N,N′-dimethylolurea, N-methylol dicyanamide, N-allyl dioxazine, N-phenyl dioxazine, N-methylol-acetamide, N-methylol-butyramide, N-methylol-acrylamide, N-methylol-succinimide, lauryloxymethylpyridinium chloride, ethoxymethylpyridinium chloride, trioxane hexamethoxymethylmelamine and hexamethylolmelamine pentamethyl ether (HMPE). The methylenes donor agent is able to react with the methylenes acceptor agent typically forming a lattice, remaining wholly or partially incorporated therein.

The term “methylenes acceptor agent” refers to an aromatic organic agent, such as phenol and its derivatives, resorcinol, cresol and the like, capable of reacting with a methylenes donor agent through an aromatic electrophilic substitution reaction and formation of a lattice.

The cross-linking resin may be a reactive phenol-formaldehyde, resorcinol-formaldehyde, cresol-formaldehyde or similar resin and mixtures thereof. Commercial examples of suitable phenolic cross-linking resins are those produced by SI Group, with different grades and trade names such as Elaztobond™, SP (such as SP-1045H), BRJ, HRJ or others from different manufacturers such as Akrochem, Sino Legend or Kolon.

The suitable vulcanisation activators optionally present preferably are zinc agents, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, as well as BiO, PbO, Pb₃O₄, PbO₂ or mixtures thereof. Commercial examples are Wuhan Jinghe's Dispersing Agent FS-200 fatty acid zinc salts, KLK OLEO's Palmera B1810 stearic acid or U.S. Zinc grade 203 zinc oxide.

In a preferred embodiment, the vulcanisation activator is not present.

The optional vulcanisation accelerant agent is preferably selected from dithiocarbamates, guanidines, thioureas, thiazoles, sulphenamides, sulphenimides, thiurams, amines, xanthates and mixtures thereof.

Preferably, the accelerant agent is selected from N-cyclohexyl-2-benzothiazol-sulphenamide (CBS), N-tert-butyl-2-benzothiazol-sulphenamide (TBBS) and mixtures thereof.

A commercial example of a suitable accelerant agent is N-cyclohexyl-2-benzothiazol-sulphenamide Vulkacit® (CBS) marketed by Lanxess.

The vulcanisation accelerant agent may be present in the cross-linkable elastomeric composition in an overall amount generally from 0.05 phr to 10 phr, preferably from 0.1 phr to 5 phr.

The cross-linkable and expandable elastomeric composition may comprise one or more vulcanisation accelerants as defined above in mixture.

Preferably, in the present cross-linkable and expandable elastomeric composition the accelerant agent is not present.

The optional vulcanisation retardant agent may be selected for example from urea, phthalic anhydride, N-nitrosodiphenylamine N-cyclohexylthiophthalimide (CTP), and mixtures thereof.

A commercial example of a suitable retardant agent is N-cyclohexylthiophthalimide VULKALENT G of Lanxess.

The retardant agent may be present in the cross-linkable and expandable elastomeric composition in an amount generally of from 0.05 phr to 2 phr.

In a preferred embodiment, the retardant agent is not present.

The expanding agent preferably used in the cross-linkable and expandable elastomeric compound of the noise-reducing element according to the present invention is selected from the group of diazo, dinitrose, hydrazide, carbazide, semi-carbazide, tetrazole, carbonate, bicarbonate, citrate agents and mixtures thereof, as described in particular in publication WO2011/064128.

Among these, one may mention in particular dinitro-pentane-ethylene tetramine, dinitro-pentane-styrene tetramine, N,N′-dimethyl-N, N′-dinitroso-phthalamide, azodicarbonamide, benzene sulphonyl hydrazide, toluene sulphonyl hydrazide, p,p′-oxy bis(benzenesulphonyl) hydrazide, p-toluene sulphonyl semicarbazide, p,p′-oxy bis(benzenesulphonyl) semicarbazide, and mixtures thereof.

The expanding agent preferably used in the cross-linkable and expandable elastomeric compound of the noise-reducing element according to the present invention is azodicarbonamide.

The elastomeric composition preferably comprises from 10 phr to 20 phr of said expanding agent.

The fatty acid amides optionally used in the present composition derive from the corresponding saturated, monounsaturated and polyunsaturated fatty acids by substitution of the —OH group of the carboxylic acid by an —NR₁R₂ group, where R₁ and R₂ represent, independently of each other, a hydrogen atom or a linear or branched alkyl having from 1 to 6 carbon atoms, preferably from 1 to 4 carbon atoms, preferably methyl, ethyl, propyl, isopropyl, butyl, isobutyl, and tert-butyl. Saturated fatty acids from which the amides useful in the present invention may be obtained are, for example, butyric acid, valeric acid (valerianic acid), capronic acid, enanthic acid, caprylic acid, pelargonic acid, capric acid, lauric acid, myristic acid, palmitic acid, margaric acid, stearic acid, arachic acid, behenic acid, lignoceric acid, cerotic acid, montanic acid, melissic acid, and laceroic acid.

Monounsaturated fatty acids from which the amides useful in the present invention may be obtained are, for example, myristoleic acid, sapienic acid, palmitoleic acid, heptadecenoic acid, oleic acid, elaidic acid, vaccenic acid, trans-vaccenic acid, asclepic acid, cis-vaccenic acid, petroselinic acid, petroselinic acid, gadoleic acid, gondoic acid, cetoleic acid, erucic acid, and nervonic acid.

Polyunsaturated fatty acids from which the amides useful in the present invention may be obtained are, for example, linoleic acid, rumenic acid, α-linolenic acid, γ-linolenic acid, stearidonic acid, arachidonic acid, timnodonic acid, clupanodonic acid, and cervonic acid.

The fatty acid amides useful in the present invention are, for example, stearamide, oleamide, erucamide, behenamide, lauramide, palmitamide, butyramide, and so on. Commercial examples of the fatty acid amides useful in the present invention are the amides marketed by Croda Italia SpA under the trade name of Crodamide™ or Incroslip™, such as for example Crodamide™ SR, Crodamide™ ER, Crodamide™ BR, Crodamide™ ORX, Crodamide™ S, Crodamide™ EBS, Crodamide™ OR, and Crodamide™ SRV, and by Fine Organics under the trade names Finawax S, Finawax S 50, Finawax S 70.

The elastomeric composition may preferably comprise from 10 phr to 30 phr, more preferably from 10 phr to 20 phr of said fatty acid amides.

Without wishing to be bound to any explanation, the Applicant believes that the use of said fatty acid amides contributes to the homogeneous dispersion of the polar components of the present composition in the apolar elastomeric mass, in particular of the expanding agent and consequently of the gas produced by it, making the distribution thereof even and therefore improving the properties of the expanded material.

In the present elastomeric composition there are one or more polymers and copolymers of one or more hydroxy acids, preferably selected from polymers and copolymers of caprolactone, lactic acid, and glycolic acid and mixtures thereof.

Without wishing to be bound to any explanation, the Applicant believes that the use of (co) polymers of hydroxy acids, such as polycaprolactone and the like, gives the present expanded compound gas barrier properties which advantageously allow the same to be retained inside the noise-reducing element, improving the expansion and soundproofing efficiency thereof.

Examples of polymers and copolymers useful in the present invention are represented by polycaprolactones (PCL), polylactides (PLA or polylactic acid), polyglycolides (PGA), poly (caprolactones-co-lactides), poly(lactides-co-glycolides) (PLGA), poly(caprolactones-co-glycolides) and mixtures thereof.

The polycaprolactones useful in the present invention may be obtained by annular opening polymerization from caprolactone in the presence of metallic organic agents (e.g., tin tetraphenyl) as catalyst and dihydroxyl (such as butylene glycol) or trihydroxyl (such as trimethylolpropane) or tetrahydroxyl (such as trimethylolpropane) or tetrahydroxyl agents (such as pentaerythritol) as an initiator. Commercial examples of polycaprolactones useful in the present invention are the polycaprolactones marketed by Ingevity under the trade name of Capa™, such as Capa 2125, Capa 2045, Capa 2100J, Capa 2101, Capa 2101A, Capa 2125, Capa 2141A, Capa 2161A, Capa 2200J, Capa 2201, Capa 2201A, Capa 2202AJ, Capa 2203A, Capa 2204J, Capa 2205, Capa 2209, Capa 2241A, Capa 2302J, Capa 3022, Capa 3041, Capa 3201, Capa 6800, Capa 6250, and Capa 7201A. Further examples of polycaprolactones useful in the present invention are available under the trade name TONE, such as TONE 300 and TONE 700, marketed by Union Carbide Corporation Danbury, Connecticut.

Commercial examples of polylactides useful in the present invention are available from Chronopol Inc. (Golden, CO), from NatureWorks LLC under the trade name EcoPLA™, from Mutsui Chemical under the trade name Lacea®, and from Biomer under the trade name L5000™.

The elastomeric composition preferably comprises from 2 phr to 15 phr, more preferably from 3 phr to 12 phr of the aforementioned polymers and copolymers of one or more hydroxy acids, preferably of polymers and copolymers of caprolactone, lactic acid, and glycolic acid.

The elastomeric composition of the present invention does not comprise urea in amounts greater than 0.5 phr, preferably than 0.1 phr, more preferably urea is absent.

The Applicant has mainly focused on applying the compound and the noise-reducing element of the invention to tyres for four-wheeled vehicles for road use, as tyres adapted to equip medium and high powered cars for transporting people (maximum chord size from 195 mm to 245 mm). The Applicant believes that the invention is also adapted for tyres for small cars or high-performance tyres (HP high performance-UHP ultra high performance) with maximum chord size, for example, of from 145 mm to 355 mm, or tyres for various vehicles such as motorcycles or heavy load vehicles for transporting people or property.

The soundproof tyre may be an HP (High Performance) or UHP (Ultra High Performance) tyre intended for equipping vehicles for the transport mainly of people, such as Sedan, Minivan, family, SUVs (Sport Utility Vehicles) and/or CUVs (Crossover Utility Vehicles), typically tyres that allow driving at high speeds.

The high and ultra-high performance tyres are in particular those which allow to reach speeds higher than at least 160 km/h, higher than 200 km/h up to over 300 km/h. Examples of such tyres are those belonging to the classes “T”, “U”, “H”, “V”, “Z”, “W”, “Y” according to the E.T.R.T.O. standard. (European Tyre and Rim Technical Organisation) standards, in particular for four-wheel high-power vehicles. Typically, the tyres belonging to these classes have a section width equal to 185 mm or greater, preferably not greater than 325 mm, more preferably of between 195 mm and 325 mm. These tyres are preferably mounted on rims having seating diameters equal to or larger than 15 inches, preferably not larger than 24 inches, more preferably of between 17 inches and 22 inches. By SUV and CUV it is meant vehicles with raised distribution, typically four-wheel drive, typically having a displacement greater than or equal to 1800 cc, more preferably of between 2000 cc and 6200 cc. Preferably, these vehicles have a mass greater than 1400 kg, more preferably of between 1500 Kg and 3000 Kg.

The tyre of the invention may be used as a summer or winter or “all-season” (tyres usable in all seasons) tyre.

The tyre of the invention may be used as a tyre for electric vehicles.

In the tyre of the invention, the at least one noise-reducing element made of expanded elastomeric material may be arranged on at least a portion of the radially internal surface of the vulcanised layer of air-impermeable elastomeric compound (liner).

In one embodiment, the noise-reducing element is disposed on at least a portion of the radially internal surface of the vulcanised layer of airtight elastomeric compound and extends axially at least at a part of the tread band.

Preferably, the at least one noise-reducing element is arranged on the radially internal surface of the vulcanised layer of air-impermeable elastomeric compound which extends along the entire circumference of the tyre and axially at least at a part of the tread band of the tyre, for example for 20%, 30%, 40%, 50%, 60%, 70%, 80% or 90% of the tread extension, being preferably arranged across the equatorial plane.

Alternatively, the at least one noise-reducing element may extend axially for a width corresponding to 100% or more of the width of the tread band, i.e. it may extend over the radially internal surface of the vulcanised layer of airtight elastomeric compound corresponding to the sidewalls, in all or in part, preferably comprised between 10% and 70% of said surface.

Preferably, the at least one noise-reducing element is disposed on the radially internal surface of the vulcanised layer of airtight elastomeric compound axially extending in a substantially centred position with respect to the equatorial plane of the tyre.

In one embodiment, the tyre comprises a single noise-reducing element, in the form of a continuous strip joined at the ends, for example with dimensions 180 mm×2 mm and a length equal to the circumference of the tyre, said element being arranged circumferentially in a radially internal position with respect to the vulcanised layer of air-impermeable elastomeric compound.

Alternatively, multiple noise-reducing elements of different sizes and shapes may be arranged side by side, for example square in shape (e.g. measuring 180 mm×180 mm×2 mm), as shown illustratively in FIG. 8A, or rectangular or multiple continuous strips placed side by side and joined at the ends as shown for example in FIG. 8B.

Preferably, the number of strips of material is greater than or equal to 1, preferably between 2 and 8, preferably less than 10.

In the tyre according to the present invention, the noise-reducing element may be arranged circumferentially on the radially internal surface of the vulcanised layer of airtight elastomeric compound as a single strip or as multiple strips parallel to the equatorial plane or alternatively, inclined with respect to such plane by an angle for example between +/−30°. Such strips may substantially be rectangular portions, having a width preferably less than the cross-sectional width (maximum chord) of the tyre and length equal to or different from each other, preferably comprised between 0.5 and 0.05 of the internal circumferential development of the tyre; such substantially rectangular portions are disposed preferably in a substantially centred position with respect to the equatorial plane of the tyre.

Preferably, the noise-reducing element is disposed in such a way as to distribute the load as symmetrically as possible, so as not to unbalance the tyre posture.

Preferably, the noise-reducing element is disposed avoiding the overlapping of the end flaps of one or more strips of material.

Preferably the coverage of the radially internal surface of the vulcanised layer of airtight elastomeric compound is less than 100% and preferably greater than 40%, more preferably greater than 50%, even more preferably greater than 60%.

In another embodiment, the noise-reducing element may be arranged inside the carcass structure.

In this embodiment, the noise-reducing element in the carcass may be arranged in a radially external position with respect to the liner and internal with respect to the belt structure. Alternatively, it may be arranged in a radially external position with respect to the belt structure and internal with respect to the tread band.

In a preferred embodiment, the noise-reducing element in the carcass is arranged in a radially external position with respect to the layer of elastomeric material called “underliner”—said underliner being in a radially external position and adjacent to the liner—and radially internal with respect to the belt structure.

Advantageously, the noise-reducing element arranged in the carcass is better protected from degradation caused by external agents, such as for example oxygen or ozone; furthermore, it allows the rolling noise to be intercepted and contributes, especially if used together with another reducing element arranged in the cavity, to an effective soundproofing action.

The soundproof tyre according to the invention may comprise at least one noise-reducing element in the internal cavity, arranged in a radially internal position with respect to the vulcanised layer of air-impermeable elastomeric compound and extending axially at least at a part of the tread band, or at least a noise-reducing element arranged inside the carcass structure or at least one noise-reducing element both in the internal cavity and in the carcass structure.

Further features and advantages will appear more clearly from the detailed description of two non-exclusive embodiments of a soundproof tyre according to the present invention.

### BRIEF DESCRIPTION OF THE DRAWINGS

The accompanying drawings are provided for indicative and, thus, non-limiting purpose only.

FIG. 1 schematically shows a radial half-section of a soundproof tyre for vehicle wheels, comprising a noise-reducing element in the internal cavity.

FIG. 2 schematically shows a radial half-section of a soundproof tyre for vehicle wheels, comprising the noise-reducing element in the carcass structure.

FIG. 3 shows, in a partial exploded schematic view, an overlap of layers making up a tyre according to an embodiment of the invention.

FIG. 4 shows photographs of the samples made respectively with the compound B and C of Example 1 after expansion and cross-linking.

FIG. 5 shows the MDR diagram with the pressure P/torque S′ curves during the first 10 minutes of cross-linking at 170° of the compound A of Example 1.

FIG. 6 shows the MDR diagram with the pressure P/torque S′ curves during the first 10 minutes of cross-linking at 170° of the compound B of Example 1.

FIG. 7 shows the MDR diagram with the pressure P/torque S′ curves during the first 10 minutes of cross-linking at 170° of the compound C of Example 1.

FIG. 8 shows photographs of soundproof tires including noise-reducing elements according to the invention. FIG. 8A and FIG. 8B show multiple noise-reducing elements of different shapes, applied to the radially internal surface of the vulcanised layer of air-impermeable elastomeric compound (8A squares, 8B elongated strips). FIG. 8C shows a photograph of the radially internal surface of a soundproof tyre including the noise-reducing element in the carcass structure, positioned radially externally with respect to the liner.

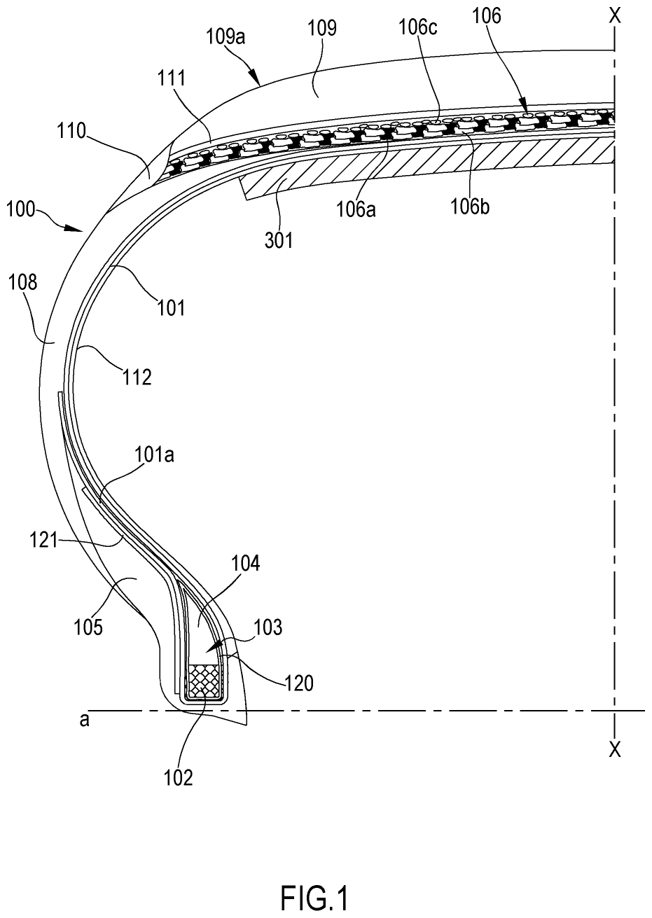

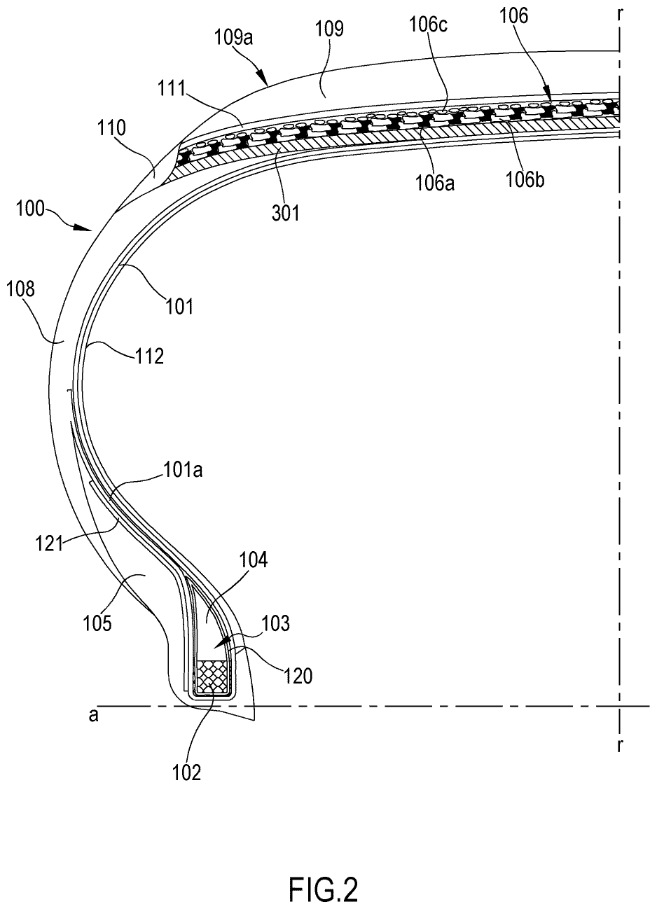

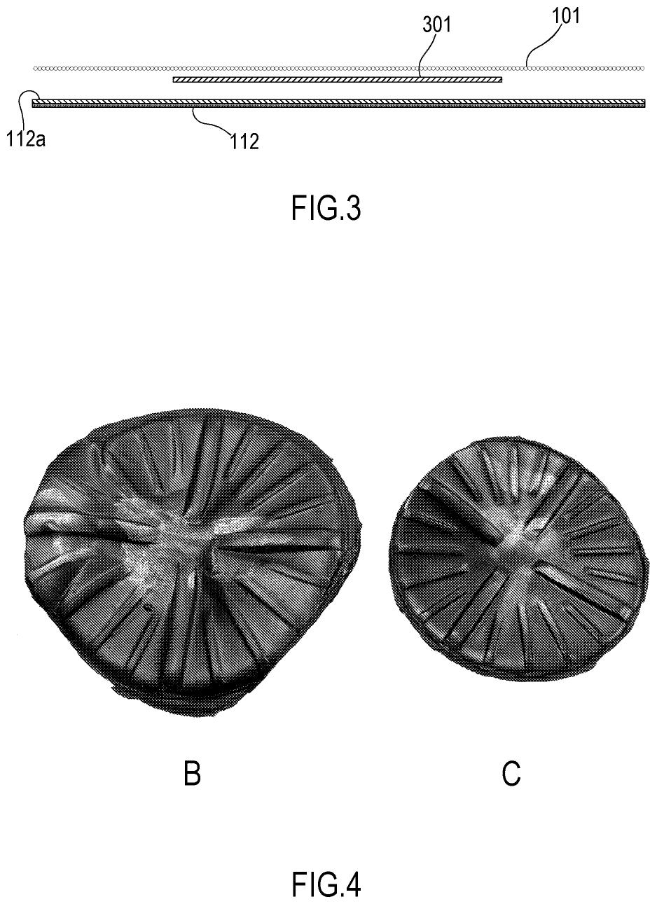

The description of embodiments of the invention is set out below with reference to the drawings of FIG. 1, FIG. 2 and FIG. 3 provided for indicative and non-limiting purposes only, where “a” indicates an axial direction and “r” indicates a radial direction. For simplicity, FIG. 1 and FIG. 2 show only a part of the tyre, the remaining part not shown being identical and disposed symmetrically with respect to the radial direction “r”.

Reference numeral 100 indicates in FIG. 1 a soundproof tyre for vehicle wheels, comprising a noise-reducing element in the internal cavity. The tyre generally comprises a carcass structure, comprising at least one carcass ply or layer 101 having respectively opposite end flaps engaged with respective annular anchoring structures 102, referred to as bead cores, optionally associated to a bead filler 104. The tyre area comprising the bead core 102 and the filler 104 forms a bead structure 103 intended for anchoring the tyre onto a corresponding mounting rim, not shown. Each bead structure 103 is associated to the carcass structure by folding back of the opposite lateral edges of the at least one carcass layer 101 around the bead core 102 so as to form the so-called carcass flaps 101a as shown in FIG. 1. The at least one carcass layer 101 of the carcass structure is optionally associated with a belt structure 106 comprising one or more belt layers 106a, 106b placed in radial superposition with respect to one another and with respect to the carcass structure 101, having metal or textile reinforcing cords. Such reinforcing cords may have crossed orientation with respect to a circumferential extension direction of the tyre 100. By “circumferential” direction we mean a direction generally facing according to the direction of rotation of the tyre, or in any case slightly inclined with respect to the direction of rotation of the tyre.

The belt structure 106 further comprises at least one radially external reinforcing layer 106c with respect to the belt layers 106a, 106b. The radially external reinforcing layer 106c comprises textile or metal cords, disposed according to a substantially zero angle with respect to the circumferential extension direction of the tyre and immersed in the elastomeric material. Preferably, the cords are disposed substantially parallel and side by side to form a plurality of turns. Such turns are substantially oriented according to the circumferential direction (typically with an angle of between 0° and) 5°, such direction being usually called “zero degrees” with reference to the laying thereof with respect to the equatorial plane X-X of the tyre. By “equatorial plane” of the tyre it is meant a plane perpendicular to the axis of rotation of the tyre and which divides the tyre into two symmetrically equal parts. A tread band 109 is disposed in a radially external position with respect to the carcass structure and/or if present (as in the illustrated case) to the belt structure 106.

In a radially external position, the tread band 109 has a rolling portion 109a intended to come into contact with the ground. Circumferential grooves, which are connected by transverse notches (not shown in FIG. 1) so as to define a plurality of blocks of various shapes and sizes distributed in the rolling portion 109a, are generally made in this portion 109a, which for simplicity is represented smooth in FIG. 1.

To optimise the performance of the tread, the tread band may be made in a two-layer structure.

Such two-layer structure comprises the rolling layer or portion 109a (called cap) and a substrate 111 (called base) forming the so-called cap-and-base structure. It is thus possible to use an elastomeric material capable of providing a low rolling resistance for the cap 109a and at the same time high resistance to wear and to the formation of cracks while the elastomeric material of the substrate 111 may be particularly aimed at a low hysteresis to cooperate in reducing rolling resistance. The under-layer 111 of vulcanised elastomeric compound may be disposed between the belt structure 106 and the rolling portion 109a.

On the lateral surfaces of the at least one carcass layer 101 of the carcass structure, respective sidewalls 108 of vulcanised elastomeric compound, each extending from one of the lateral edges of the tread band 109 up to the respective bead structure 103, are furthermore arranged in a position axially external to said carcass structures.

A strip consisting of elastomeric compound 110, commonly known as “mini-sidewall”, of vulcanised elastomeric compound may optionally be provided in the connecting zone between sidewalls 108 and the tread band 109, this mini-sidewall generally being obtained by co-extrusion with the tread band 109 and allowing an improvement of the mechanical interaction between the tread band 109 and the sidewalls 108. Preferably, the end portion of sidewall 108 directly covers the lateral edge of the tread band 109.

In some specific embodiments, such as the one illustrated and described herein, the stiffness of the bead 103 may be improved by providing a reinforcing layer 120 generally known as a “flipper” in the tyre bead.

The flipper 120 is wrapped around the respective bead core 102 and the bead filler 104 so as to at least partially surround them. The flipper 120 is disposed between the carcass layer 101 and the bead structure 103. Usually, the flipper 120 is in contact with the carcass layer 101 and said bead structure 103. The flipper 120 typically comprises a plurality of metal or textile cords incorporated in a vulcanised elastomeric compound.

In some specific embodiments, such as the one illustrated and described herein, the bead structure 103 may further comprise a further protective layer 121 which is generally known by the term of “chafer”, or protective strip, and which has the function to increase the rigidity and integrity of the bead structure 103.

The chafer 121 usually comprises a plurality of cords incorporated in a vulcanised elastomeric compound; such cords are generally made of textile material (for example aramid or rayon), or of metallic material (for example steel cords).

Optionally, an anti-abrasive strip 105 is disposed so as to wrap the bead structure 103 along the axially internal and external and radially internal areas of the bead structure 103, thus interposing itself between the latter and the wheel rim when the tyre 100 is mounted on the rim.

Moreover, a radially internal surface of tyre 100 is preferably internally lined by a layer of substantially airtight elastomeric material, or so-called liner 112.

With reference to FIG. 1, a noise-reducing element of expanded elastomeric material 301 made by cross-linking the cross-linkable and expandable elastomeric composition according to the present invention is adhered by co-vulcanisation to the radially internal surface of the layer of airtight elastomeric material 112, occupying in axial extension at least a part of the crown portion of the tyre.

In another embodiment, illustrated in FIG. 2, the at least one noise-reducing element 301 may be arranged between the at least one carcass layer 101 of the carcass structure and the belt structure 106.

Alternatively, in another embodiment of the soundproof tyre represented schematically as a partial exploded view in FIG. 3, the at least one noise-reducing element 301 may be arranged adjacent to the at least one layer 101 of the carcass structure at least for a portion of the latter in a radially external position with respect to the vulcanised layer of air-impermeable elastomeric compound 112 and to an “underliner” 112a. The underliner 112a (shown schematically in FIG. 3) is arranged in a position adjacent to and radially external to the liner 112, and radially internal to the at least one carcass layer 101 of the carcass structure.

Preferably, when the at least one noise-reducing element is arranged adjacent to the carcass structure, said element comprises elastomeric compounds having the same or similar polymeric composition as the compounds of the tyre elements adjacent to it, in order to guarantee the greatest possible compatibility between the layers and prevent them from detaching during use.

Preferably but non-exclusively, the tyre 100 for motor vehicles is of the HP (High-Performance) or UHP (Ultra High-Performance) type, i.e. it is a tyre capable of withstanding maximum speeds of at least 190 Km/h, up to over 300 Km/h. Examples of such tyres are those belonging to the classes “T”, “U”, “H”, “V”, “Z”, “W”, “Y”. According to an embodiment not shown, the tyre may be a tyre for motorcycle wheels. The profile of the straight section of the tyre for motorcycle (not shown) has a high transversal curvature since it must guarantee a sufficient footprint area in all the inclination conditions of the motorcycle. The transverse curvature is defined by the value of the ratio between the distance f of the ridge of the tread from the line passing through the laterally opposite ends of the tread itself, measured on the equatorial plane of the tyre, and the width C defined by the distance between the laterally opposite ends of the tread itself. A tyre with high transverse curvature indicates a tyre whose transverse curvature ratio (f/C) is at least 0.20.

The building of the tyre 100 as described above is carried out by assembling respective semi-finished products onto a forming drum, not shown, by at least one assembly device.

At least a part of the components intended to form the carcass structure of the tyre 100 is built and/or assembled on the forming drum. More specifically, in the case of application on the vulcanised layer of air-impermeable elastomeric compound (liner 112) (FIG. 1), the forming drum is suitable to first receive the noise-reducing element 301 made with the cross-linkable and expandable elastomeric compound according to the present invention, then the liner 112, and subsequently the carcass ply or layer 101.

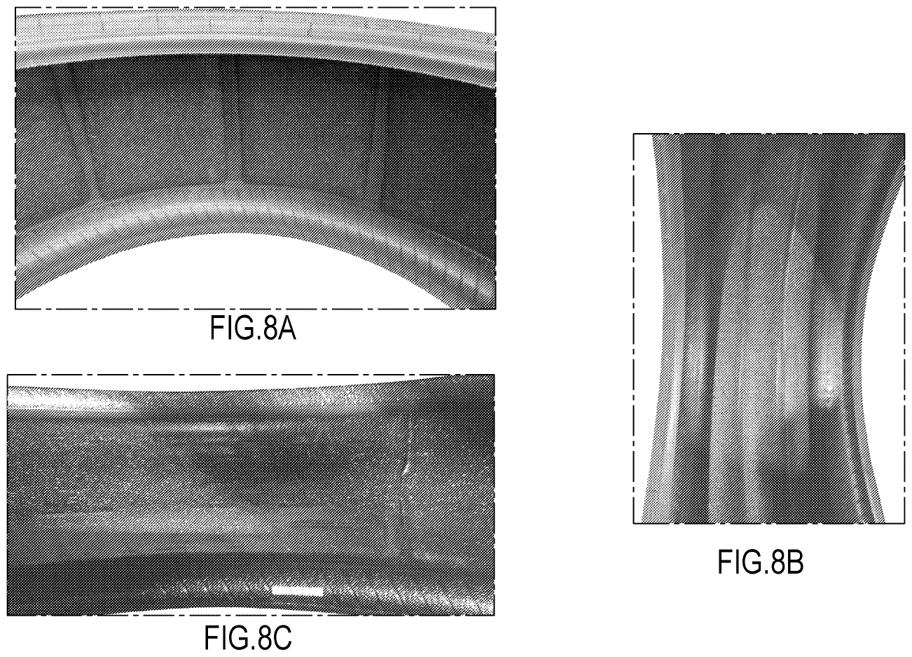

Instead, in the case of the application with a noise-reducing element arranged at least partially adjacent to the carcass structure, illustrated in FIG. 2, in FIG. 3 and in FIG. 8C, the noise-reducing element 301 made with the cross-linkable and expandable elastomeric compound according to the present invention, is positioned after the application of the liner 112 and optionally of the further “underliner” layer 112a on the drum.

Thereafter, devices non shown coaxially engage one of the annular anchoring structures 102 around each of the end flaps, position an external sleeve comprising the belt structure 106 and the tread band 109 in a coaxially centred position around the cylindrical carcass sleeve and shape the carcass sleeve according to a toroidal configuration through a radial expansion of the at least one carcass ply 101, so as to cause the application thereof against a radially internal surface of the external sleeve.

After building of the green tyre 100, a moulding and vulcanisation treatment is generally carried out in order to determine the structural stabilization of the tyre 100 through vulcanisation of the elastomeric compounds, as well as to impart a desired tread pattern on the tread band 109 and any distinguishing graphic signs at the sidewalls 108.

The vulcanised tyre, after being extracted from the vulcanisation chamber, is kept at rest at room temperature for a variable period of time, for example between about 5 minutes and about 20 minutes in order to allow the expansion of the elastomeric material of the noise-reducing element 301.

Alternatively, in the embodiment of FIG. 2, the green noise-reducing element 301 is inserted during the manufacturing of the green tyre 100 in a position radially external to the carcass structure, and expanded and co-cross-linked during vulcanisation in the mould, as described above.

Alternatively, the tyre 100 is made and vulcanised without the noise-reducing element 301. In this case, the noise-reducing element may be applied in a radially internal position to the vulcanised layer of air-impermeable elastomeric compound (liner) of the finished tyre, when green, and be expanded and cross-linked there, in a subsequent step.

Alternatively, the noise-reducing element may be applied with suitable adhesive agents to the finished tyre, after having been expanded and cross-linked separately. The present invention will be further illustrated below with a number of preparatory examples, which are provided for illustrative and non-limiting purposes only.

### EXAMPLES

### Example 1

### Preparation of the Expandable Elastomeric Compounds a, B and C

The composition of the expandable elastomeric compounds A, B and C is illustrated in the following Table 1. All values are expressed in phr.

TABLE 1
elastomeric compositions

| | A | B | C |
|---|---|---|---|
| | Invention | Invention | Comparison |
| NR | 80 | 80 | 80 |
| IR | 20 | 20 | 20 |
| Carbon black | 10 | 45 | 45 |
| Silica | 50 | — | — |
| Silane | 4 | — | — |
| Silane 2 | 2 | — | — |
| Expanding agent | 15 | 15 | 15 |
| Polycaprolactone | 10 | 10 | — |
| Stearic acid | 2 | 2 | 2 |
| ZnO | 3.6 | 3 | 3 |
| Vulcanising agent | — | — | 5 |
| Cross-linking resin | 10 | 10 | — |

Composition C: according to the teaching of WO2015014577A1 (Table 1 C-3).
NR: natural rubber (Standard Thai Rubber STR 20 - Thaiteck Rubber);
IR: isoprene rubber (SKI 3 gr 2 - Aneka Bumi Pratama)
Carbon black: N234 from Cabot Corporation;
Silica: ZEOSIL ® 1165 MP, standard grade with surface area of approximately 175 m2/g from Solvay;
Silane: bis[3-(triethoxysilyl)propyl]tetrasulphide JH-S69 from ChemSpec Ltd;
Silane 2: 50% mixture of bis[3-(triethoxysilyl)propyl]tetrasulphide from Evonik
Expanding agent: Unicell D200A azodicarbonamide from Tramaco
Polycaprolactone: Polycaprolactone diol terminated Capa 2125 from Ingevity
ZnO: Standard Zn oxide from A-Esse;
Vulcanising agent: Insoluble sulphur 67%, Solfotecnica
Cross-linking resin: octylphenol-formaldehyde resin with free methylol, SP-1045H resin from SI GROUP.

Starting from the elastomeric compositions shown in Table 1, the corresponding elastomeric compounds were prepared according to the following process.

The mixing of the components was carried out in two steps using an internal mixer (Banbury, Intermix or Brabender).

In the first mixing step (1) all the ingredients were introduced with the exception of the vulcanising agent and the cross-linking resin. The mixing was continued for a maximum time of 5 minutes, reaching a temperature of approximately 145° C. Subsequently, in the second mixing step (2), again carried out using an internal mixer, the cross-linking resin and the vulcanising agent, respectively, were added, and the mixing was continued for about 4 minutes while maintaining the temperature below 100° C.

The compounds were then unloaded and calendared to obtain a circular sample with a diameter of about 40 mm and a thickness of about 2 mm which was subjected to MDR rheometric analysis carried out according to the ISO 6502 method, with an Alpha Technologies model MDR2000 rheometer, at 170° C. and for 10 minutes with a pressure cell and 100% filling of the vulcanisation chamber.

The samples obtained with compound A and with compound B of the invention showed a much greater expansion (of about 40% in volume and about 29% in volume, respectively) compared to that of the samples obtained with the comparison compound C and a higher level of porosity.

FIG. 4 shows photographs of the samples obtained with compounds B and C, after expansion and cross-linking (diameter: 6.7 cm and 5.2 cm, respectively) from which the greater expansion of compound B according to the invention was apparent.

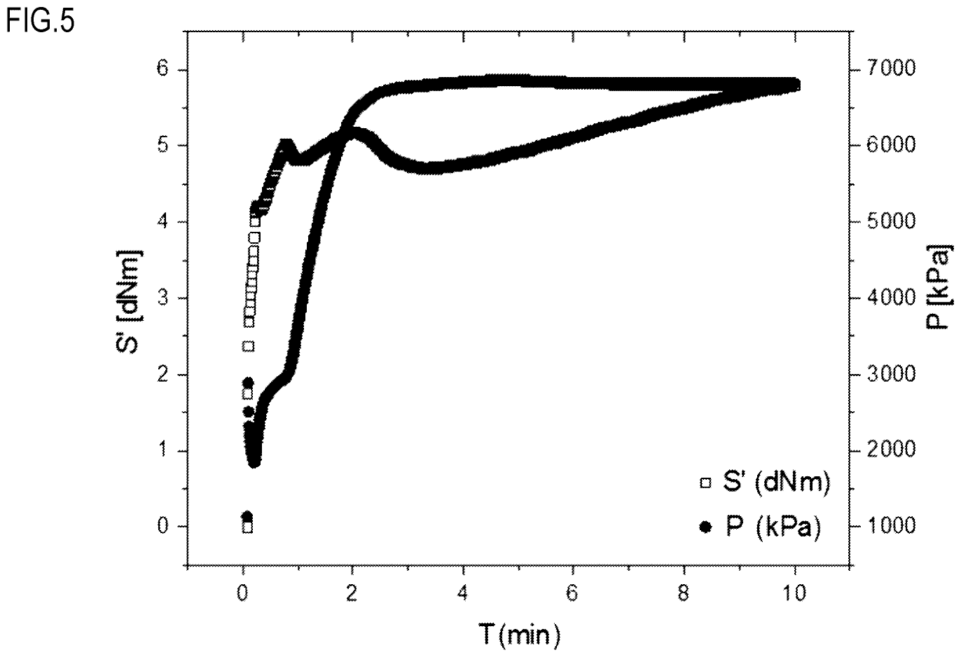

FIG. 5 shows the MDR (torque S′) and pressure (P) graph obtained with compound A after 10 minutes. The pressure curve shows a rapid and substantially constant pressure increase up to a maximum of 7000 kPa, demonstrating that compound A was able to effectively retain the gas released inside it, explaining the greater swelling found.

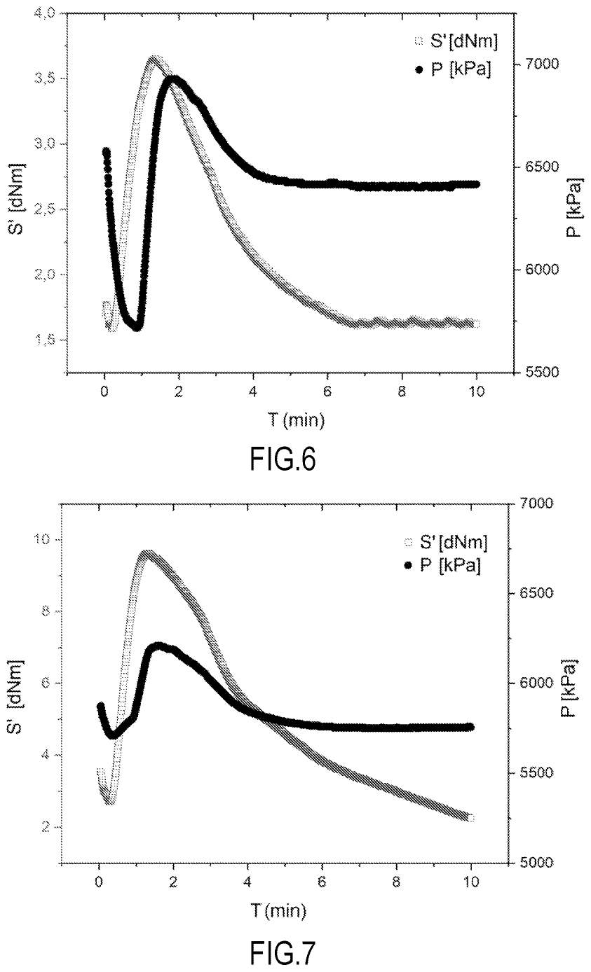

FIG. 6 shows the MDR (torque S′) and pressure (P) graph obtained with compound B after 10 minutes. The pressure curve showed a rapid pressure increase from a minimum of 5700 KPa up to a maximum of approximately 7000 kPa, followed by a decay to approximately 6420 kPa in the final reversion step, demonstrating a good pressure increase (approximately 1300 KPa) and therefore expansion of the compound. Furthermore, from the graph it appeared that compound B was able to effectively retain the gas released inside it, explaining the greater swelling detected.

FIG. 7 shows the MDR (torque S′) and pressure (P) graph obtained with the comparison compound C after 10 minutes. The pressure curve clearly showed a pressure increase of only 500 KPa, decidedly lower than that of compound B, from a minimum of 5700 KPa to a maximum of 6200 KPa, followed by a pressure decay up to 5760 KPa, very close to the minimum pressure. From these data it was highlighted that compound C did not give rise to a satisfactory increase in pressure, and therefore to an appreciable increase in volume of the compound and that it was unable to retain the gas released within it very effectively, explaining the limited swelling detected.

### Example 2

### Preparation and Characterisation of Tyres 1 and 2

Compound A described in Example 1 was used in the preparation of a 255/40R20 Pirelli P ZERO™ soundproof tyre for all seasons by placing a green layer of compound having a thickness of approximately 3 mm, a width of approximately 180 mm and a length equal to the circumference of the tyre (tyre 1 of the invention) on the radially internal surface of the underliner, symmetrically with respect to the equatorial plane. The same tyre without the layer of soundproofing compound was used as a reference (Tyre 2).

The green tyre was then subjected to a conventional vulcanisation process, observing in the finished tyre 1 the maintenance of the transverse dimension of the noise-reducing element of approximately 180 mm with an increase in its thickness of between 150 and 200%.

The tyre was then subjected to the noise assessment test according to the SAE J2710 method by spinning the tyre mounted on a rim connected to an engine on a road wheel having a rough surface.

Due to the rolling of the tyre on the surface of the road wheel, vibrations are created in the tyre which are partially transmitted to the air, becoming noise measured in dB. The test consists in bringing the wheel to the speed of 150 km/hour, leaving it free and measuring the noise up to the speed of 20 km/hour, for a total of about 10 minutes of noise acquisition.

In this test, the tyre according to the invention showed a significant reduction in noise compared to the reference tyre while maintaining structural integrity.

1-13. (canceled)

14. A cross-linkable and expandable elastomeric compound obtained by mixing an elastomeric composition, wherein the elastomeric composition comprises:
(i) 100 phr of at least one natural or synthetic elastomeric polymer,
(ii) from about 10 phr to about 80 phr of at least one reinforcing filler,
(iii) from about 0 phr to about 3 phr of at least one vulcanising agent,
(iv) from about 2 phr to about 25 phr of at least one cross-linking resin,
(v) from about 5 phr to about 30 phr of at least one expanding agent,
(vi) from about 0 phr to about 40 phr of at least one agent chosen from a fatty acid amides group, and
(vii) from about 1 phr to about 20 phr of at least one agent chosen from a group of polymers and copolymers of one or more hydroxy acids.

15. The compound according to claim 14 wherein the natural or synthetic elastomeric polymer is chosen from natural rubber, synthetic isoprene rubber and mixtures thereof.

16. The compound according to claim 14, wherein the reinforcing filler is in an amount of at least 30 phr.

17. The compound according to claim 14, wherein the vulcanising agent is present in an amount of less than 2.5 phr.

18. The compound according to claim 14, wherein the cross-linking resin comprises at least one methylene donor agent and at least one methylene acceptor agent.

19. The compound according to claim 14 wherein the cross-linking resin is in an amount ranging from about 2 phr to about 25 phr.

20. The compound according to claim 14, wherein the expanding agent is chosen from the group of diazo, dinitroso, hydrazide, carbazide, semi-carbazide, tetrazole, carbonate, bicarbonate, citrate agents and mixtures thereof.

21. The compound according to claim 14, wherein the polymers and copolymers of one or more hydroxy acids are chosen from polymers and copolymers of caprolactone, lactic acid, glycolic acid and mixtures thereof.

22. The compound according to claim 14, wherein the at least one agent chosen from the group of polymers and copolymers of one or more hydroxy acids is in an amount ranging from about 2 phr to about 15 phr.

23. The compound according to claim 14, wherein the elastomeric composition does not include urea.

24. A noise-reducing element made by cross-linking and expanding the cross-linkable and expandable elastomeric compound according to claim 14.

25. A soundproof tyre for vehicle wheel comprising:
a carcass structure;
a tread band in a position radially outward from the carcass structure;
a vulcanised layer of air-impermeable elastomeric compound (liner), arranged radially inside the carcass structure;
at least one noise-reducing element made of expanded elastomeric material;
wherein the at least one noise-reducing element is made by cross-linking and expanding a cross-linkable and expandable elastomeric compound according claim 14.

26. The soundproof tyre according to claim 25 wherein the at least one noise-reducing element is disposed in radially internal position of the vulcanised layer of air-impermeable elastomeric compound and/or the at least one noise-reducing element is disposed adjacent to the carcass structure.

27. The compound according to claim 15 wherein the natural or synthetic elastomeric polymer consists of natural rubber, synthetic isoprene rubber or mixtures thereof.

28. The compound according to claim 16, wherein the reinforcing filler is in an amount of at least 40 phr.

29. The compound according to claim 17, wherein the vulcanising agent is in an amount of less than 2.0 phr or 1.0 phr.

30. The compound according to claim 17, wherein the vulcanising agent is absent.

31. The compound according to claim 18, wherein the cross-linking resin is chosen from phenol-formaldehyde resin, resorcinol-formaldehyde resin, cresol-formaldehyde resin and mixtures thereof.

32. The compound according to claim 19, wherein the cross-linking resin is in an amount ranging from 8 phr to 20 phr.

33. The compound according to claim 14, wherein the expanding agent is azodicarbonamide.

34. The compound according to claim 22, wherein the at least one agent chosen from the group of polymers and copolymers of one or more hydroxy acids is in an amount ranging from 3 phr to 12 phr.

35. The compound according to claim 15 wherein the natural or synthetic diene elastomeric polymer consists of natural rubber, synthetic isoprene rubber or mixtures thereof and wherein the vulcanizing agent is absent.
